(19) United States
(12) Patent Application Publication
(10) Pub. No.: US 2011/0310080 A1
(43) Pub. Date: Dec. 22, 2011

(54) DRIVE CIRCUIT, DRIVE METHOD, AND DISPLAY DEVICE

(75) Inventor: Fumio TONOMURA, Kanagawa (JP)

(73) Assignee: RENESAS ELECTRONICS CORPORATION, Kanagawa (JP)

(21) Appl. No.: 13/165,218

(22) Filed: Jun. 21, 2011

(30) Foreign Application Priority Data
Jun. 22, 2010 (JP) 2010-141567

(51) Int. Cl. G09G 5/00

(52) U.S. Cl. 345/211

(57) ABSTRACT

Provided is a drive circuit including a PDAC and an NDAC that respectively select a positive gray scale voltage and a negative gray scale voltage according to gray scale data, a positive Amp and a negative Amp, an output selection switch that inverts outputs of the positive Amp and the negative Amp, an output switch that makes switching to disconnect an amplifier output from data lines during a switching period, a charge share switch that short-circuits the data lines during the switching period, and data selector circuits that set an amplifier input to a fixed voltage not dependent on a gray scale voltage corresponding to gray scale data for display during the switching period.

### INCORPORATION BY REFERENCE

This application is based upon and claims the benefit of priority from Japanese patent application No. 2010-141567, filed on Jun. 22, 2010, the disclosure of which is incorporated herein in its entirety by reference.

### BACKGROUND

The present invention relates to a drive circuit, a drive method and a display device and, particularly, to a drive circuit that supplies a gray scale voltage to a display panel, a drive method, and a display device using the same.

Large liquid crystal panels have shifted increasingly toward high definition (HD) and to support high quality videos by double-speed frame driving or the like. For such reasons, one horizontal display period allocated to a liquid crystal panel is shortened. In other words, a write period for liquid crystals is shortened. In such a trend, a higher slew rate is required for a display driver (drive circuit). Further, picture quality requirements are becoming more stringent, and a display driver with no vertical stripes and no luminance difference is demanded.

### SUMMARY

An example of the drive circuit disclosed in Japanese Unexamined Patent Publication No. 2007-052396 (which is referred to hereinafter as patent literature 1) is described hereinbelow with reference to FIGS. 10 and 11. FIG. 10 is a view equivalent to the circuit shown in FIG. 4 of the patent literature 1. FIG. 11 shows an operating waveform of the drive circuit of FIG. 10. As shown in FIG. 10, the drive circuit 5 includes a positive DAC (hereinafter referred to as PDAC) 11, a negative DAC (hereinafter referred to as NDAC) 12, a positive Amp 13, a negative Amp 14, an output selection switch SW15, an output switch SW16, and a charge share switch SW17.

Further, in FIGS. 10 and 11, a polarity inversion signal that is supplied from a timing controller is indicated by POL, and a data output timing signal is indicated by STB. FIG. 10 shows a configuration in which the output selection switch SW15 is in the state where the polarity inversion signal POL is H, and the output switch SW16 and the charge share switch SW17 are in the state where the data output timing signal STB is L. The data output timing signal STB is in synchronization with a horizontal synchronizing signal Hsync. The state where the polarity inversion signal POL is H and the data output timing signal STB is H is as follows.

Gray scale voltages VP0 to VP63 and VN0 to VN63 corresponding to gray scale data DP[5:0] and gray scale data DN[5:0] are respectively selected by the PDAC 11 and the NDAC 12. Then, the gray scale voltage VP0 to VP63 and VN0 to VN63 that are selected by the PDAC 11 and the NDAC 12 are respectively input to the positive Amp 13 and the negative Amp 14. When the polarity inversion signal POL is H, the output of the positive Amp 13 is connected to an even number output Sn side, and the output of the negative Amp 14 is connected to an odd number output Sn+1 side by the output selection switch SW15. Further, when the data output timing signal STB is H, the output switch SW16 is OFF, and the charge share switch SW17 is ON, and thereby a charge share period occurs. In this state, the outputs of the positive Amp 13 and the negative Amp 14 change to given gray scale voltages that are selected by the PDAC 11 and the NDAC 12.

On the other hand, the even number output Sn and the odd number output Sn+1 are short-circuited and both connected to a common line 6. The even number output Sn and the odd number output Sn+1 thereby become a charge share voltage (which is ½ of a power supply voltage VDD2). The voltage at this time is as shown in the period 1 in FIG. 11. Specifically, a difference occurs between the output of the positive Amp 13 and the voltage of the even number output Sn, and a difference occurs between the output of the negative Amp 14 and the voltage of the odd number output Sn+1.

Next, the time after transition to the state where the polarity inversion signal POL is H and the data output timing signal STB is L is as follows. The output switch SW16 becomes ON, and the charge share switch SW17 becomes OFF. Thus, the positive Amp 13 is connected to the even number output Sn, and the negative Amp 14 is connected to the odd number output Sn+1, each through the output switch SW16. A load of the even number output Sn is thereby rapidly charged by the positive Amp 13. Then, the voltage of the even number output Sn is raised up to the output voltage of the positive Amp 13. Likewise, a load of the odd number output Sn+1 is thereby rapidly discharged by the negative Amp 14. Then, the voltage of the odd number output Sn+1 is lowered down to the output voltage of the negative Amp 14. The state at this time is as shown in the period 2 in FIG. 11.

Another drive circuit is described hereinafter with reference to FIGS. 12 and 13. FIG. 12 is a view equivalent to the circuit shown in

FIG. 1 of the patent literature 1. FIG. 13 shows an operating waveform of the drive circuit of FIG. 12. As shown in FIG. 12, the drive circuit 5 includes a positive DAC (hereinafter referred to as PDAC) 21, a negative DAC (hereinafter referred to as NDAC) 22, an even number Amp 23, an odd number Amp 24, an amplifier input selection switch SW25, an output switch SW26, and a charge share switch SW27.

The state where the polarity inversion signal POL is H and the data output timing signal STB is H is as follows. Gray scale voltages VP0 to VP63 and VN0 to VN63 corresponding to gray scale data DP[5:0] and gray scale data DN[5:0] are respectively selected by the PDAC 21 and the NDAC 22. When the polarity inversion signal POL is H, the output of the PDAC 21 is input to the even number Amp 23, and the output of the NDAC 22 is input to the odd number Amp 24. In this state, the outputs of the even number Amp 23 and the odd number Amp 24 change to given gray scale voltages that are selected by the PDAC 21 and the NDAC 22.

On the other hand, the even number output Sn and the odd number output Sn+1 are short-circuited and both connected to a common line 6. The even number output Sn and the odd number output Sn+1 thereby become a charge share voltage (which is ½ of a power supply voltage VDD2). The state at this time is as shown in the period 1 in FIG. 13. Specifically, a difference occurs between the output voltage of the even number Amp 23 and the voltage of the even number output Sn, and a difference occurs between the output voltage of the odd number Amp 24 and the voltage of the odd number output Sn+1.

Next, the time after transition to the state where the polarity inversion signal POL is H and the data output timing signal STB is L is as follows. The output switch SW16 becomes ON, and the charge share switch SW17 becomes OFF. Thus, the output of the even number Amp 23 is connected to the even number output Sn, and the output of the odd number Amp 24 is connected to the odd number output Sn+1, each through the output switch SW26. After that, the voltage of the even number output Sn is raised up to the output voltage of the even number Amp 23. Likewise, the voltage of the odd number output Sn+1 is lowered down to the output voltage of the odd number Amp 24. The state at this time is as shown in the period 2 in FIG. 13.

As described above, according to the drive method of the patent literature 1, a difference occurs between the output voltage of the amplifier and the output voltage of the drive circuit 5 during the charge share period (the period 1 in FIGS. 11 and 13). Due to the voltage difference, rapid charge/discharge to/from a load is thereby made upon the end of the charge share period. Accordingly, a rush current flows as shown in FIG. 14. This causes significant variation in the power supply voltage VDD2 and VSS2 or a counter electrode voltage VCOM of a liquid crystal panel 1, which can lead to the degradation of display quality.

A first aspect of the present invention is a drive circuit that supplies a gray scale voltage to a plurality of data lines included in a display panel, the drive circuit including a positive DAC circuit that selects a positive gray scale voltage according to gray scale data, a negative DAC circuit that selects a negative gray scale voltage according to gray scale data, an amplifier circuit that is connected to each of the positive DAC circuit and the negative DAC circuit, a negative-positive inverter circuit that switches between a first operation for supplying the positive gray scale voltage to a first data line group and supplying the negative gray scale voltage to a second data line group, and a second operation for supplying the positive gray scale voltage to the second data line group and supplying the negative gray scale voltage to the first data line group, an amplifier output cutoff circuit that makes switching to disconnect an amplifier output of the amplifier circuit from the data lines during a switching period of the first operation and the second operation, a charge share circuit that short-circuits a data line in the first data line group and a data line in the second data line group during the switching period, and an amplifier input switch circuit that sets an input of the amplifier circuit to a fixed voltage not dependent on a gray scale voltage corresponding to gray scale data for display during the switching period.

A second aspect of the present invention is a drive method that supplies a gray scale voltage to a plurality of data lines included in a display panel, the method including performing a first operation for supplying a positive gray scale voltage to a first data line group and supplying a negative gray scale voltage to a second data line group, and a second operation for supplying the positive gray scale voltage to the second data line group and supplying the negative gray scale voltage to the first data line group, in an alternate manner, making switching to disconnect an amplifier output of an amplifier circuit that supplies the positive gray scale voltage and the negative gray scale voltage to the data lines from the data lines during a switching period of the first operation and the second operation, short-circuiting a data line in the first data line group and a data line in the second data line group during the switching period, and setting an input of the amplifier circuit that supplies the positive gray scale voltage and the negative gray scale voltage to the data lines to a fixed voltage not dependent on a gray scale voltage corresponding to gray scale data for display during the switching period.

According to the aspects of the present invention described above, it is possible to provide a drive circuit, a drive method and a display device capable of offering high display quality.

### BRIEF DESCRIPTION OF THE DRAWINGS

The above and other aspects, advantages and features will be more apparent from the following description of certain embodiments taken in conjunction with the accompanying drawings, in which:

FIG. 1 is a timing chart showing an operating waveform of a drive circuit according to an embodiment of the present invention;

FIG. 2 is a view schematically showing a configuration of a drive circuit according to a first embodiment of the present invention;

FIG. 3 is a timing chart showing an operating waveform of the drive circuit according to the first embodiment of the present invention;

FIG. 4 is a timing chart showing a waveform of a power supply voltage and a power supply current of the drive circuit according to the first embodiment of the present invention;

FIG. 5 is a view schematically showing a configuration of a drive circuit according to a second embodiment of the present invention;

FIG. 6 is a timing chart showing an operating waveform of the drive circuit according to the second embodiment of the present invention;

FIG. 7 is a view schematically showing a configuration of a drive circuit according to a third embodiment of the present invention;

FIG. 8 is a view schematically showing a configuration of a drive circuit according to a fourth embodiment of the present invention;

FIG. 9 is a timing chart showing an operating waveform of a drive circuit according to a fifth embodiment of the present invention;

FIG. 10 is a view schematically showing a configuration of a drive circuit disclosed in the patent literature 1;

FIG. 11 is a timing chart showing an operating waveform of the drive circuit disclosed in the patent literature 1;

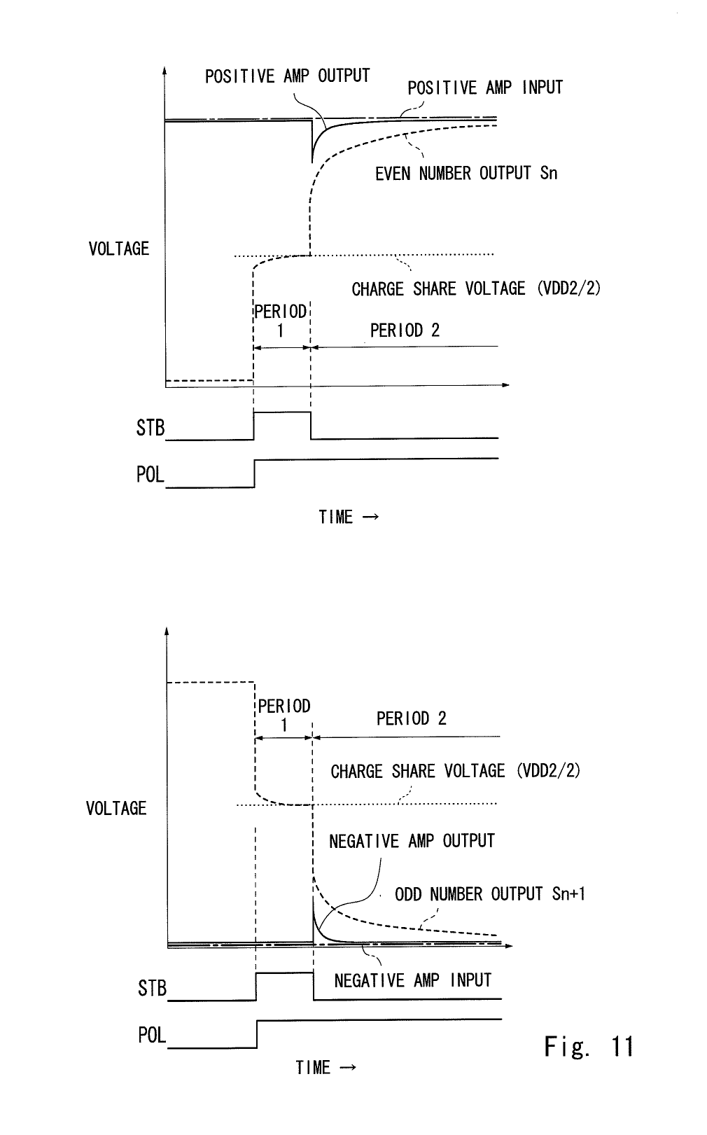

FIG. 12 is a view schematically showing another configuration of the drive circuit disclosed in the patent literature 1;

FIG. 13 is a timing chart showing another operating waveform of the drive circuit disclosed in the patent literature 1; and

FIG. 14 is a timing chart showing a power supply voltage waveform of the drive circuit disclosed in the patent literature 1.

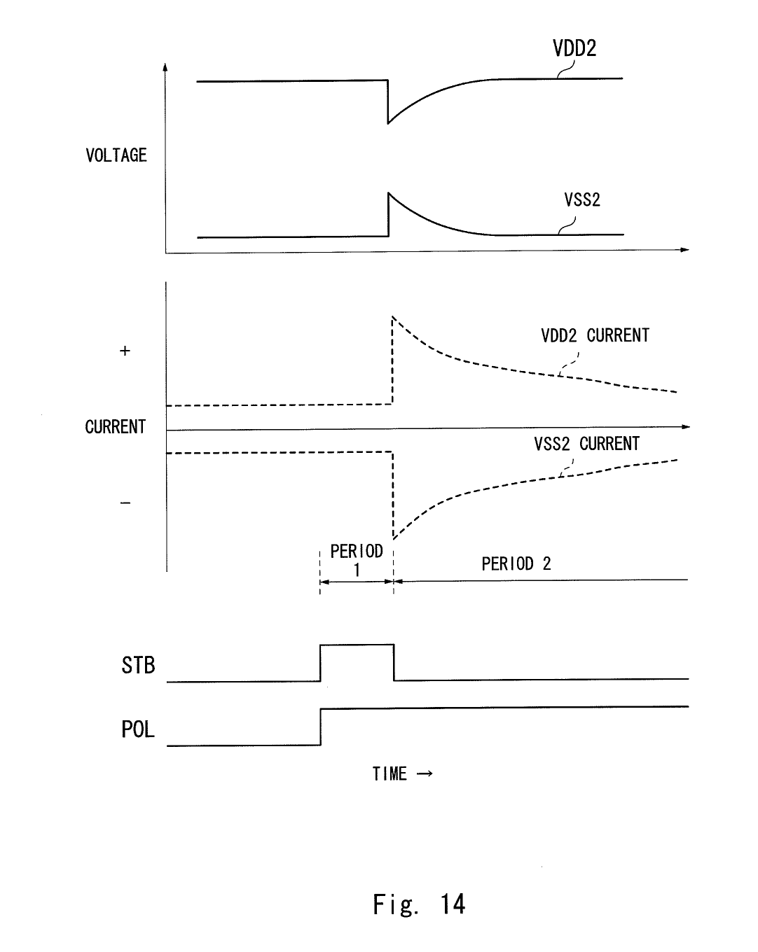

### DETAILED DESCRIPTION

Embodiments of the present invention will be explained hereinbelow with reference to the drawings. The present invention, however, is not limited to the following embodiments. Further, the following description and the attached drawings are appropriately shortened and simplified to clarify the explanation.

A drive circuit according to an embodiment of the present invention includes a positive DAC circuit, a negative DAC circuit, an amplifier circuit, a negative-positive inverter circuit, an amplifier output cutoff circuit, a charge share circuit, and an amplifier input switch circuit.

The positive DAC circuit selects a positive gray scale voltage according to gray scale data. The negative DAC circuit selects a negative gray scale voltage according to gray scale data. The amplifier circuit is connected to each of the positive DAC circuit and the negative DAC circuit. The negative-positive inverter circuit switches between a first operation for supplying a positive gray scale voltage to a first data line group and supplying a negative gray scale voltage to a second data line group, and a second operation for supplying a positive gray scale voltage to the second data line group and supplying a negative gray scale voltage to the first data line group. The amplifier output cutoff circuit performs switching in such a way that an amplifier output from the amplifier circuit and a data line are disconnected in a switching period of the first operation and the second operation. The charge share circuit short-circuits a data line of the first data line group and a data line of the second data line group and connects them to a common line in the switching period to thereby recover charges. Stated differently, charges accumulated in two data lines are shared. The amplifier input switch circuit sets the input of the amplifier circuit to a fixed voltage that is not dependent on a gray scale voltage corresponding to gray scale data for display during the switching period. Note that the fixed voltage is a voltage that is not dependent on a gray scale voltage corresponding to display gray scale data for next display. The fixed voltage is preferably a charge share voltage or a gray scale voltage that is closer to the charge share voltage than a voltage in the entire gray scale voltage range. Further, the fixed voltage may be fixed to a gray scale voltage that corresponds to MSB or LSB in the entire gray scale voltage range.

It should be noted that there are many known types and methods of the charge share circuit. In this embodiment, the charge share circuit short-circuits a data line of the first data line group and a data line of the second data line group and connects those data lines to a common line in accordance with the patent literature 1. It is, however, obvious that the same advantage can be attained with any type or method of the charge share circuit as long as it is a circuit that eventually short-circuits a data line charged to the positive value and a data line charged to the negative value.

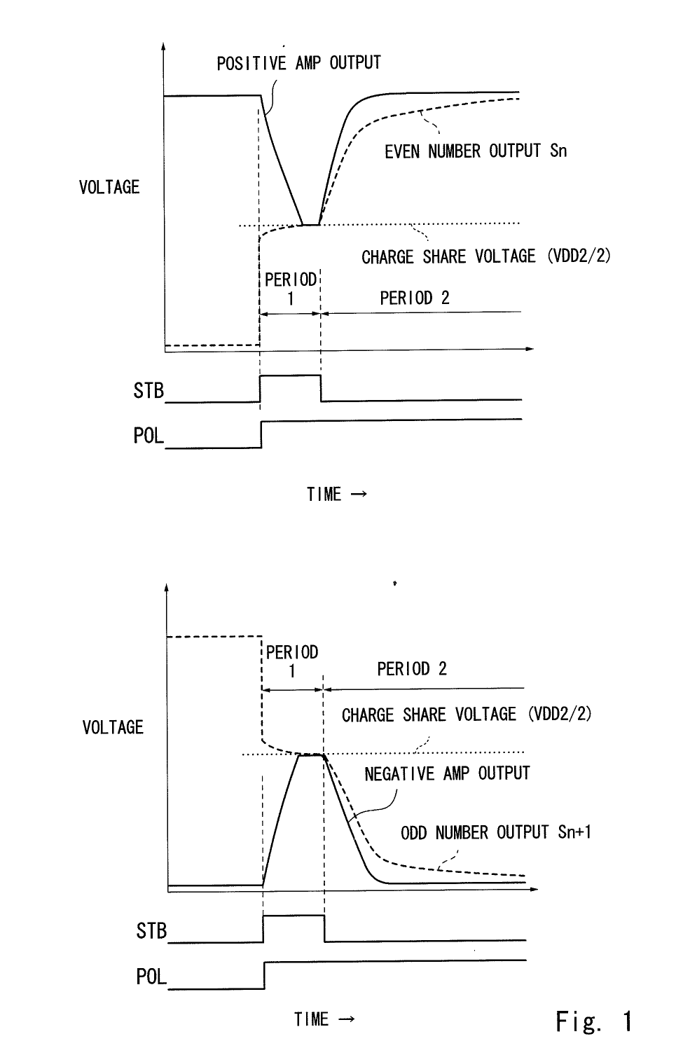

It is thereby possible to suppress a rush current and reduce the variation in the power supply voltage and the counter electrode voltage VCOM. It is thereby possible to reduce the degradation of display quality. Specifically, in a drive method according to the embodiment, the amplifier input is set to a fixed voltage during the charge share period. The fixed voltage is preferably a charge share voltage (VDD2/2) or a voltage close to the charge share voltage. In the above configuration, an operating waveform as shown in FIG. 1 can be achieved. In the charge share period (period 1), a positive Amp output is close to an even number output Sn, and a negative Amp output is close to an odd number output Sn+1. It is thus possible to suppress the variation in the power supply voltage and the counter electrode voltage VCOM upon the end of the charge share period (the timing at transition from the period 1 to the period 2). Note that, in FIG. 1, STB indicates a data output timing signal, and POL indicates a polarity inversion signal. The data output timing signal STB is in synchronization with a horizontal synchronizing signal Hsync.

### First Embodiment

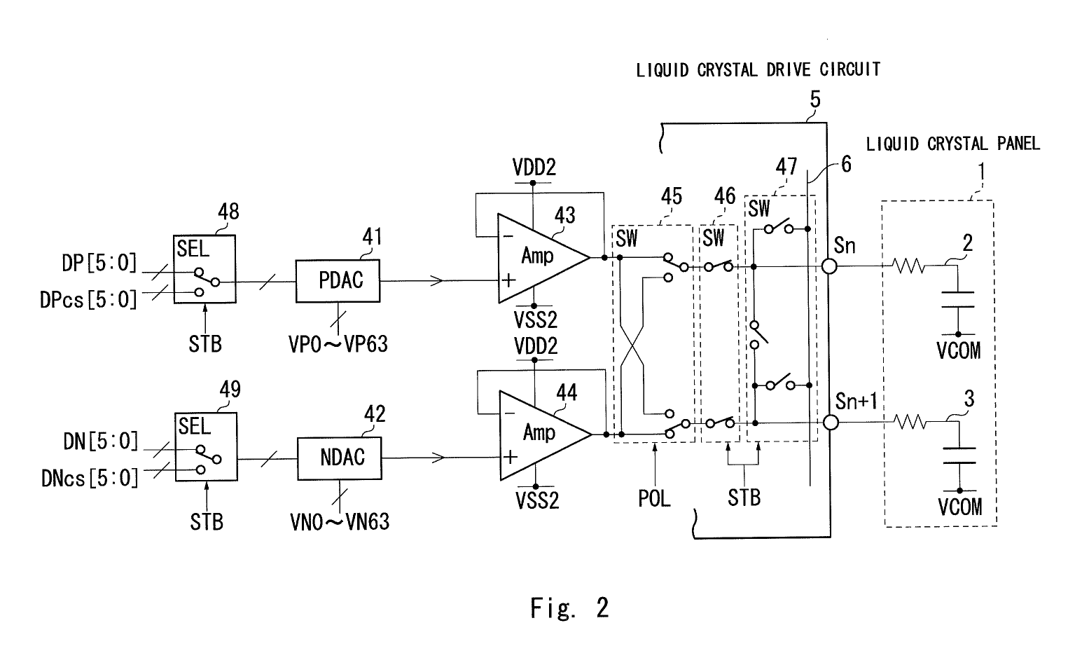

A drive circuit according to a first embodiment of the present invention is described hereinafter with reference to FIG. 2. FIG. 2 shows a configuration of a display device. A drive circuit 5 according to the embodiment is a circuit that supplies a gray scale voltage to a liquid crystal panel 1, which is a display panel. The liquid crystal panel 1 is provided with a plurality of data lines. In FIG. 2, the plurality of data lines are shown in a simplified manner, and only two data lines 2 and 3 are illustrated. In this example, the data line 2 and the data line 3 are adjacent to each other. The data line 2 is a data line included in an even number data line group, and the data line 3 is a data line included in an odd number data line group. In the following description, among output terminals of the drive circuit 5, an even number output that is connected to the data line 2 is represented as Sn, and an odd number output that is connected to the data line 3 is represented as Sn+1. Thus, the data line 2 is connected to the even number output Sn through a load, and the data line 3 is connected to the odd number output Sn+1 through a load.

The drive circuit 5 performs inversion driving of the liquid crystal panel 1 with respect to each column, for example. This prevents burn-in of liquid crystal pixels and lengthens the lifetime of a liquid crystal display device. For example, in a certain frame of simple dot inversion, a positive gray scale voltage is supplied to the even number output Sn, and a negative gray scale voltage is supplied to the odd number output Sn+1 in even number lines. On the other hand, a negative gray scale voltage is supplied to the even number output Sn, and a positive gray scale voltage is supplied to the odd number output Sn+1 in odd number lines. In the next frame, the polarity of the same pixel is inverted. Then, according to the gray scale voltage, liquid crystals of the liquid crystal panel 1 are activated, and a desired image is thereby displayed.

In FIG. 2, a polarity inversion signal and a data output timing signal that are supplied from a timing controller are respectively indicated by POL and STB. According to the polarity inversion signal POL, the polarity of each line in the inversion driving is determined. For example, when the polarity inversion signal POL is H, the even number output Sn has a positive polarity, and the odd number output Sn+1 has a negative polarity. On the other hand, when the polarity inversion signal POL is L, the even number output Sn has a negative polarity, and the odd number output Sn+1 has a positive polarity. Further, according to the data output timing signal STB, charge sharing is performed. In one horizontal period, the charge share period occurs when the data output timing signal STB is H, and a period of outputting a data signal (drive voltage), which is a given gray scale voltage, occurs when the data output timing signal STB is L. The data output timing signal STB is generated and supplied to a driver by the timing controller in synchronization with the horizontal synchronizing signal Hsync.

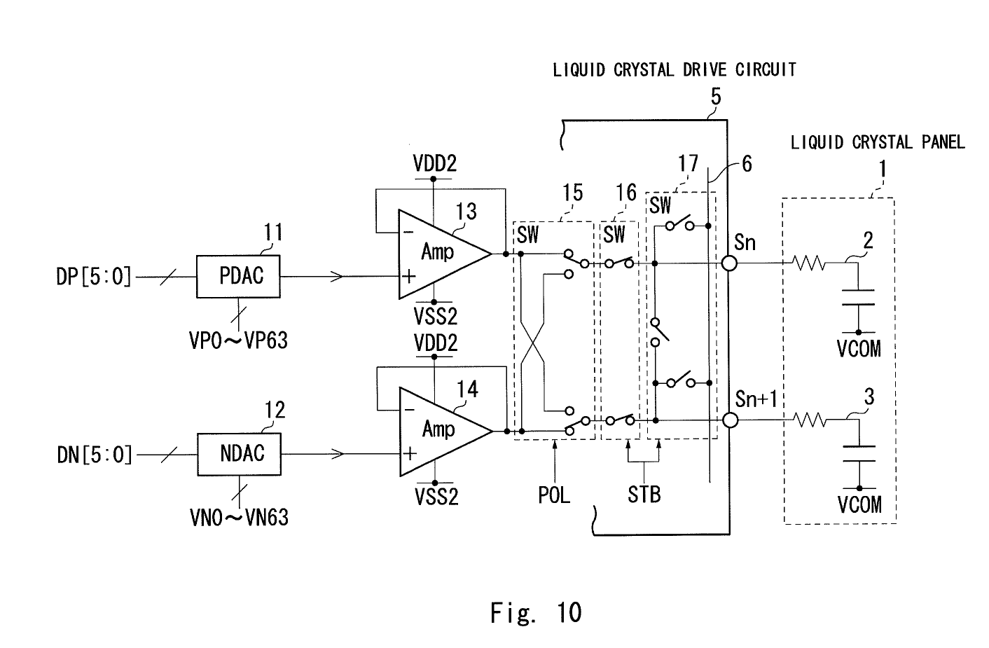

The drive circuit 5 includes a positive DAC (hereinafter referred to as PDAC) 41, a negative DAC (hereinafter referred to as NDAC) 42, a positive Amp (amplifier) 43, a negative Amp (amplifier) 44, a negative-positive inverter circuit (output selection switch SW45), an amplifier output cutoff circuit (output switch SW46), a charge share circuit (charge share switch SW47), and amplifier input switch circuits for each of positive polarity and negative polarity (a data selector circuit SEL48 and a data selector circuit SEL49). The drive circuit 5 has a configuration in which the data selector circuit SEL48 and the data selector circuit SEL49 are added to the circuit configuration shown in FIG. 10.

Gray scale data DP[5:0] and charge share gray scale data DPcs[5:0] are input to the data selector circuit SEL48 from a timing controller, for example. The gray scale data DP[5:0] and the charge share gray scale data DPcs[5:0] are 6-bit digital data. The gray scale data DP is gray scale data for displaying a desired image. The positive charge share gray scale data DPcs[5:0] is positive data that becomes a voltage which is the closest to a charge share voltage. Further, a data output timing signal STB is input to the data selector circuit SEL48. The data selector circuit SEL48 switches data to output according to the data output timing signal STB. For example, when the data output timing signal STB is H, the data selector circuit SEL48 outputs the charge share gray scale data DPcs[5:0] to the PDAC 41. When the data output timing signal STB is L, the data selector circuit SEL48 outputs the gray scale data DP[5:0] to the PDAC 41.

Likewise, gray scale data DN[5:0] and charge share gray scale data DNcs[5:0] are input to the data selector circuit SEL49. The gray scale data DN[5:0] and the charge share gray scale data DNPcs[5:0] are 6-bit digital data. The gray scale data DN is gray scale data for displaying a desired image. The negative charge share gray scale data DNcs[5:0] is negative data that becomes a voltage which is the closest to a charge share voltage. Further, a data output timing signal STB is input to the data selector circuit SEL49. The data selector circuit SEL49 switches data to output according to the data output timing signal STB. For example, when the data output timing signal STB is

H, the data selector circuit SEL49 outputs the charge share gray scale data DNcs[5:0] to the NDAC 42. When the data output timing signal STB is L, the data selector circuit SEL49 outputs the gray scale data DN[5:0] to the NDAC 42.

In the normally white (e.g. VA or STN) mode liquid crystal panel 1, most significant bit (MSB) data may be used as the positive charge share gray scale data DPcs[5:0] and the negative charge share gray scale data DNcs[5:0]. Further, in the normally black (e.g. IPS) mode liquid crystal panel 1, least significant bit (LSB) data may be used as the positive charge share gray scale data DPcs[5:0] and the negative charge share gray scale data DNcs[5:0]. Note that, in the case of 6-bit driving, MSB=111111 and LSB=000000. Use of MSB or LSB enables selection of a gray scale voltage that is the closest to a charge share voltage (½ of VDD) in the gray scale voltage range. When the charge share voltage is between the positive gray scale voltage range and the negative gray scale voltage range, the charge share gray scale data is set to MSB or LSB. Further, when the positive gray scale voltage range and the negative gray scale voltage range partly overlap, the charge share gray scale data is set to data within the overlapping range.

Positive gray scale voltages VP0 to VP63 are input to the PDAC 41. The PDAC 41 selects an arbitrary gray scale voltage according to data input from the data selector circuit SEL48. Specifically, one gray scale voltage VP that is selected according to the gray scale data DP[5:0] becomes a data signal for performing display. Likewise, negative gray scale voltages VN0 to VN63 are input to the NDAC 42. The NDAC 42 selects an arbitrary gray scale voltage according to data input from the data selector circuit SEL49. Specifically, one gray scale voltage VN that is selected according to the gray scale data DNP[5:0] becomes a data signal for performing display.

The gray scale voltage that is output from the PDAC 41 is input to the positive Amp 43. The gray scale voltage that is output from the NDAC 42 is input to the negative Amp 44. The positive Amp 43 and the negative Amp 44 perform impedance conversion of the input gray scale voltages and outputs results. A data signal having a positive potential is thereby output from the positive Amp 43, and a data signal having a negative potential is output from the negative Amp 44. The data lines 2 and 3 are driven by the data signals. Note that, in this embodiment, the positive Amp 43 and the negative Amp 44 are amplifier circuits that operate with a power supply voltage VDD2.

The outputs of the positive Amp 43 and the negative Amp 44 are connected to the output selection switch SW45. The output selection switch SW45 is a circuit that includes a plurality of switches, and it switches the selection of the amplifier output according to the polarity inversion signal POL. Specifically, when the polarity inversion signal POL is H, the output selection switch SW45 connects the output of the positive Amp 43 to the even number output Sn and connects the output of the negative Amp 44 to the odd number output Sn+1. When, on the other hand, the polarity inversion signal POL is L, the output selection switch SW45 connects the output of the negative Amp 44 to the even number output Sn and connects the output of the positive Amp 43 to the odd number output Sn+1.

The output switch SW46 is placed on the output side of the output selection switch SW45. The output switch SW46 is a circuit that includes a plurality of switches, and it switches between connection and disconnection of the amplifier output and the data line according to the data output timing signal STB. For example, when the data output timing signal STB is H, the plurality of switches are OFF. The output selection switch SW45 is thereby disconnected from the even number output Sn and the odd number output Sn+1. When, on the other hand, the data output timing signal STB is L, the plurality of switches are ON. The output selection switch SW45 is thereby connected to the even number output Sn and the odd number output Sn+1 through the output switch SW46.

The charge share switch SW47 is connected on the output side of the output switch SW46. The charge share switch SW47 is a circuit that includes a plurality of switches, and it performs charge sharing according to the data output timing signal STB. The charge sharing is performed before the polarity of a certain data line to which a load of the liquid crystal panel 1 is connected changes from positive to negative, for example, in a certain horizontal period, to short-circuit (share) positive charges in the data line and negative charges accumulated in another data line. This enables the both data lines to be pre-charged to a voltage near Vcom as an expected value without use of a power from a power supply. Power saving can be thereby accomplished.

Specifically, when the data output timing signal STB is H, the switches of the charge share switch SW47 turn ON to short-circuit the even number output Sn and the odd number output Sn+1 and connect the even number output Sn and the odd number output Sn+1 to the common line 6. The even number output Sn and the odd number output Sn+1 thereby become a charge share voltage (which is ½ of the power supply voltage VDD2 as an expected value), and the charge sharing is performed. Note that the charge share voltage is a constant voltage, which may be the same as or different from the counter electrode voltage VCOM.

On the other hand, when the data output timing signal STB is L, the switches of the charge share switch SW47 turn OFF to disconnect the even number output Sn and the odd number output Sn+1 from the common line 6. Because the output switch SW46 is ON, the amplifier outputs are connected to the even number output Sn and the odd number output Sn+1 through the output selection switch SW45 and the output switch SW46. The data signals, which are the gray scale voltages, are thereby supplied to the data lines 2 and 3.

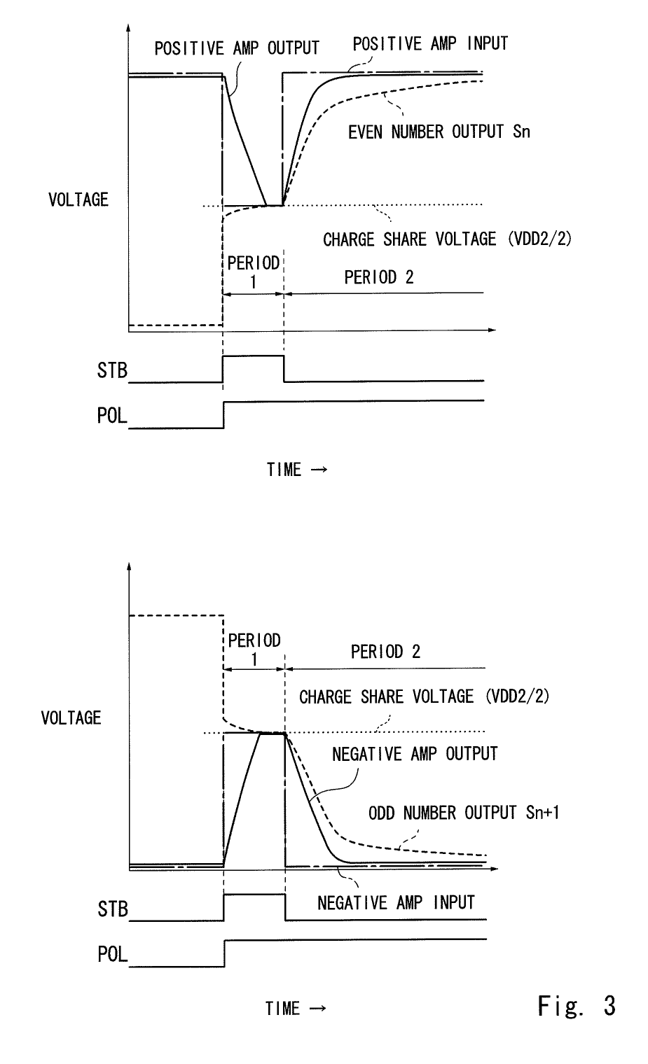

Next, the operation of the drive circuit 5 in FIG. 2 is described with reference to FIG. 3. FIG. 3 is a timing chart showing an operating waveform of the drive circuit 5. Note that a period from the rising edge of the data output timing signal STB, which is a pulse signal, to the next rising edge of the data output timing signal STB is one horizontal period. A period from the rising edge to the falling edge of one data output timing signal STB is a charge share operation period. The charge share period (the period 1 in FIG. 3) is at the beginning of one horizontal period, which is, immediately after the switching of the horizontal period.

The case where the polarity inversion signal POL is H and the data output timing signal STB is H (the period 1) is as follows. The data selector circuit SEL48 selects the charge share gray scale data DPcs and outputs it to the PDAC 41. The PDAC 41 outputs a gray scale voltage corresponding to the charge share gray scale data DPcs. On the other hand, the data selector circuit SEL49 selects the charge share gray scale data DNcs and outputs it to the NDAC 42. The NDAC 42 outputs a gray scale voltage corresponding to the charge share gray scale data DNcs. The charge share gray scale data DPcs, DNcs is a gray scale value that corresponds to a voltage which is the closest to the charge share voltage in the entire gray scale voltage range of each polarity. For example, in the normally white mode liquid crystal panel 1, a gray scale voltage VP63 corresponding to MSB is output from the PDAC 41, and a gray scale voltage VN63 corresponding to MSB is output from the NDAC 42. Accordingly, voltages which are the closest to the charge share voltage in the respective polarities are output from the PDAC 41 and the NDAC 42.

When the polarity inversion signal POL is H, the output selection switch SW45 connects the output of the positive Amp 43 to the even number output Sn side, and connects the output of the negative Amp 44 to the odd number output Sn+1 side. Further, when the data output timing signal STB is H, because it is the charge share period, the switches of the output switch SW46 are OFF, and the switches of the charge share switch SW47 are ON. At this time, the outputs of the positive Amp 43 and the negative Amp 44 respectively change to gray scale voltages which are the closest to the charge share voltage.

On the other hand, because the even number output Sn and the odd number output Sn+1 are short-circuited and both connected to the common line 6, and thereby become a charge share voltage (½ of VDD2). In this state, as shown in the period 1, the output of the positive Amp 43 and the voltage of the even number output Sn are substantially the same, and the output of the negative Amp 44 and the voltage of the odd number output Sn+1 are substantially the same.

Next, the case where the polarity inversion signal POL is H and the data output timing signal STB is L, which is the timing when the data output timing signal STB falls and transition from the period 1 to the period 2 takes place, is as follows. At this time, the switches of the output switch SW46 are ON, and the switches of the charge share switch SW47 are OFF. Thus, the output of the positive Amp 43 is connected to the even number output Sn, and the output of the negative Amp 44 is connected to the odd number output Sn+1 through the output switch SW46. Note that the state of the output selection switch SW45 does not change from the period 1.

Because the data output timing signal STB changes to L, the data selector circuit SEL48 selects and outputs the gray scale data DP[5:0] for display. The PDAC 41 thereby outputs a gray scale voltage (VP0 to VP63) corresponding to given gray scale data DP[5:0] to the positive Amp 43. The even number output Sn rises up to the gray scale voltage corresponding to the display gray scale data DP[5:0] according to a change in the output voltage of the positive Amp 43. Likewise, the data selector circuit SEL49 selects and outputs the gray scale data DN[5:0] for display. The NDAC 42 thereby outputs a gray scale voltage (VN0 to VN63) corresponding to a given gray scale data DN[5:0] to the negative Amp 44. The odd number output Sn+1 falls down to the gray scale voltage corresponding to the display gray scale data DN[5:0] according to a change in the output voltage of the negative Amp 44. The state at this time is as shown in the period 2.

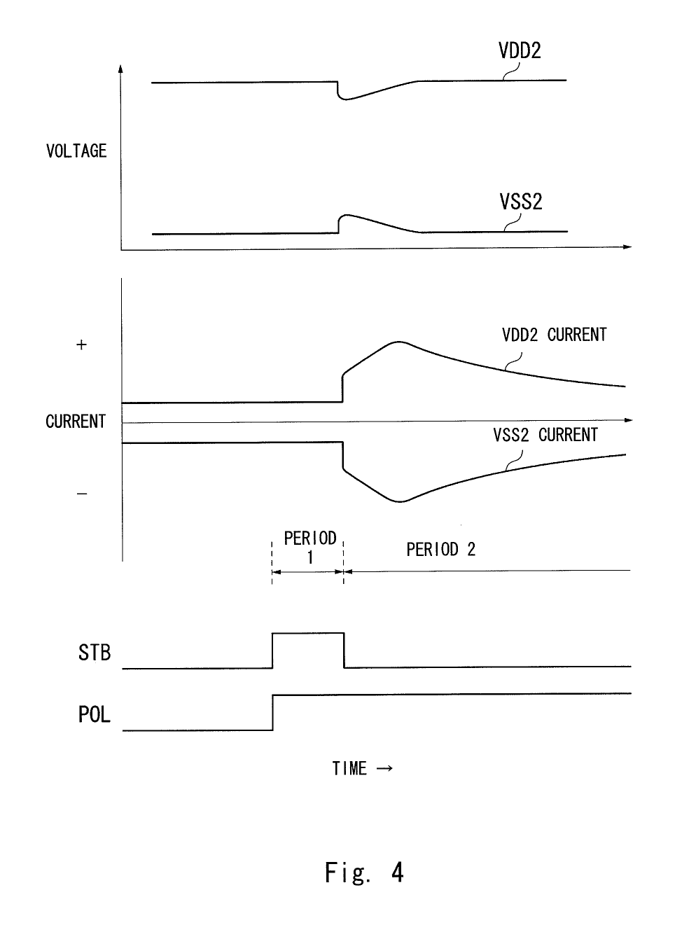

As described above, in this embodiment, the amplifier output changes to a voltage close to the charge share voltage upon the end of the charge share period. Therefore, the amplifier output and the output voltage of the drive circuit 5 have substantially the same voltage level. Thus, no significant difference occurs between the amplifier output voltage and the output voltage of the drive circuit 5 upon the end of the charge share period. The load is thereby charged in a gradual fashion with an increase and a decrease in the amplifier output voltage. As a result, the rush current is suppressed as shown in FIG. 4, and the variation in the power supply voltage and the counter electrode voltage VCOM of the liquid crystal panel can be reduced. It is thereby possible to suppress the degradation of display quality and produce a display device with high display quality.

Note that, the charge share gray scale data DPcs, DNcs is fixed to MSB or LSB in the above description; however, another value may be used. Stated differently, data of a value with which the amplifier output becomes a fixed voltage close to the charge share voltage may be used as the charge share gray scale data DPcs, DNcs. Specifically, in the case of the normally white mode liquid crystal panel 1, any data can be used as long as the high order bit is the same as MSB. For example, in the case of 6-bit gray scale data, when the high order four bits is “1111”, the value of the low order two bits is not particularly limited. In this case as well, a fixed voltage close to the charge share voltage can be obtained. Thus, a voltage that is closer to the charge share voltage than a voltage within the gray scale voltage range can be supplied. Further, in the case of the normally black mode liquid crystal panel 1, any data can be used as long as the high order bit is the same as LSB. For example, in the case of 6-bit gray scale data, when the high order four bits is “0000”, the value of the low order two bits is not particularly limited. Note that the number of high order bits which are set to be the same as MSB or LSB is not limited to four bits. Further, the fixed voltage is a voltage that is not dependent on a gray scale voltage corresponding to the gray scale data DP[5:0] or DN[5:0] for display, and it is constant over a plurality of charge share periods. Therefore, the fixed voltage is the same as the fixed voltage in the charge share voltage of the next line and frame. The fixed voltage is thus a constant voltage that is uncorrelated to the gray scale voltage corresponding to the display gray scale data DP[5:0] or DN[5:0].

It should be noted that because the data selector circuits SEL48 and SEL49 are at the previous stage of the DAC (digital-to-analog converter) in this embodiment, those circuits can be low-voltage circuits that operate with a low power supply voltage. It is thereby possible to reduce the degradation of display quality simply by adding low voltage circuits for controlling data. Further, because it is not necessary to add a high voltage circuit (a circuit with a high power supply voltage) that generally requires a large layout area, there is no significant impact in terms of area. It is thereby possible to suppress an increase in circuit size.

It should be further noted that when there is a concern for EMI or the like due to changing data all at once, time may be shifted slightly for each appropriate number of outputs. Specifically, a circuit that sets a slight shift time and changes data with respect to each predetermined number of outputs may be added.

Further, when the polarity inversion signal POL is L, the output selection switch SW45 operates to connect the positive Amp 43 to the odd number output Sn+1 and connects the negative Amp 44 to the even number output Sn. The basic operation of the charge sharing is the same as above, and therefore detailed explanation thereof is omitted below.

### Second Embodiment

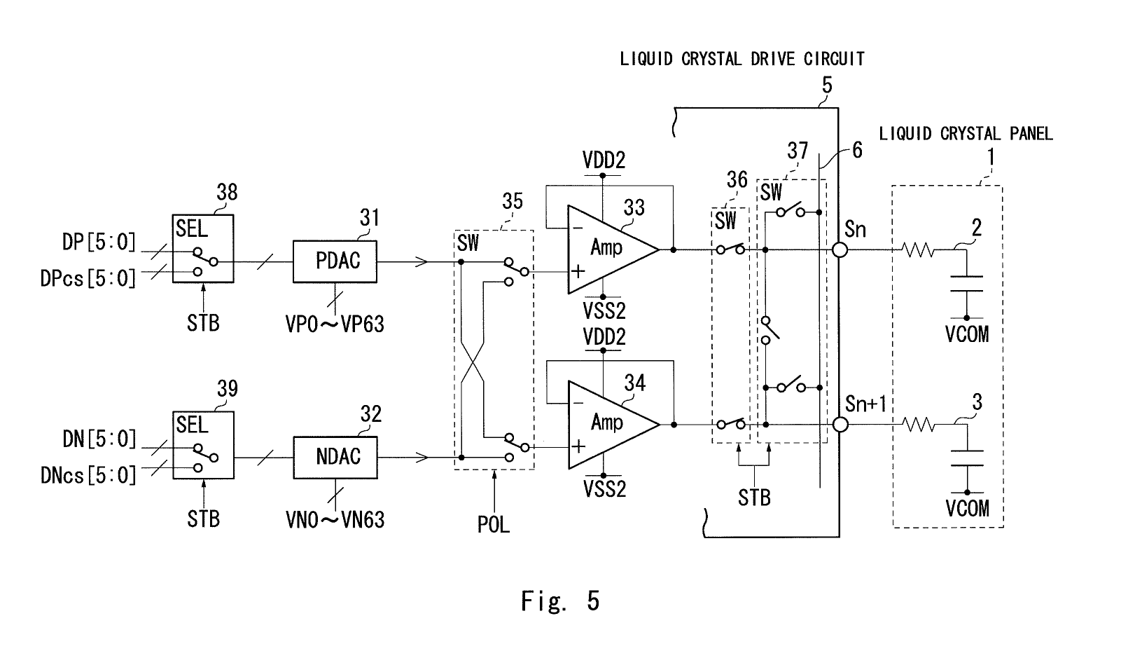

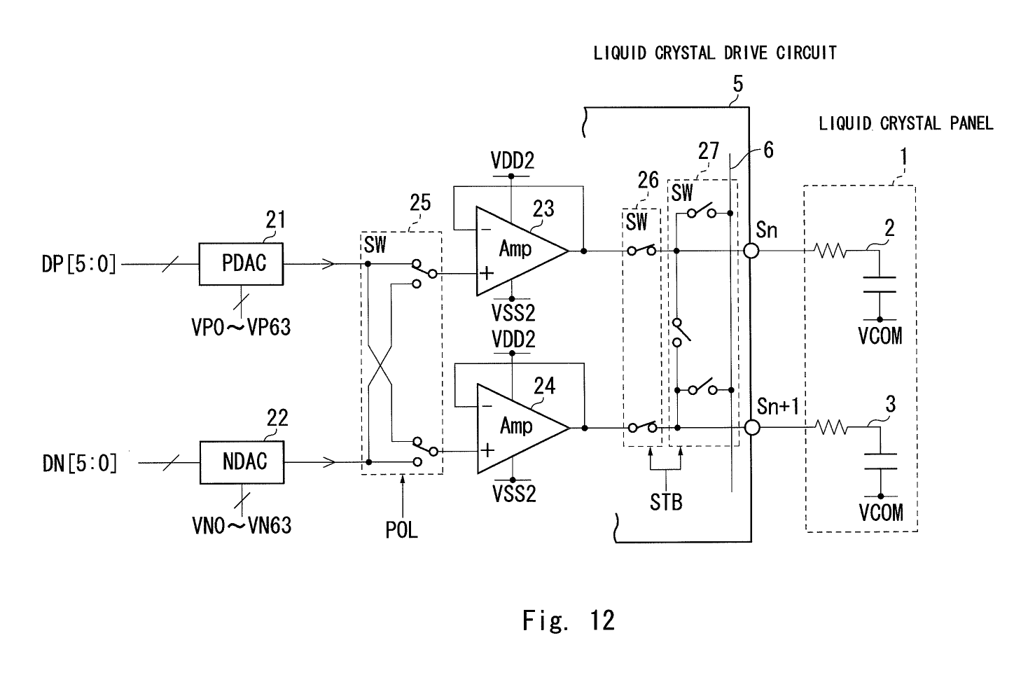

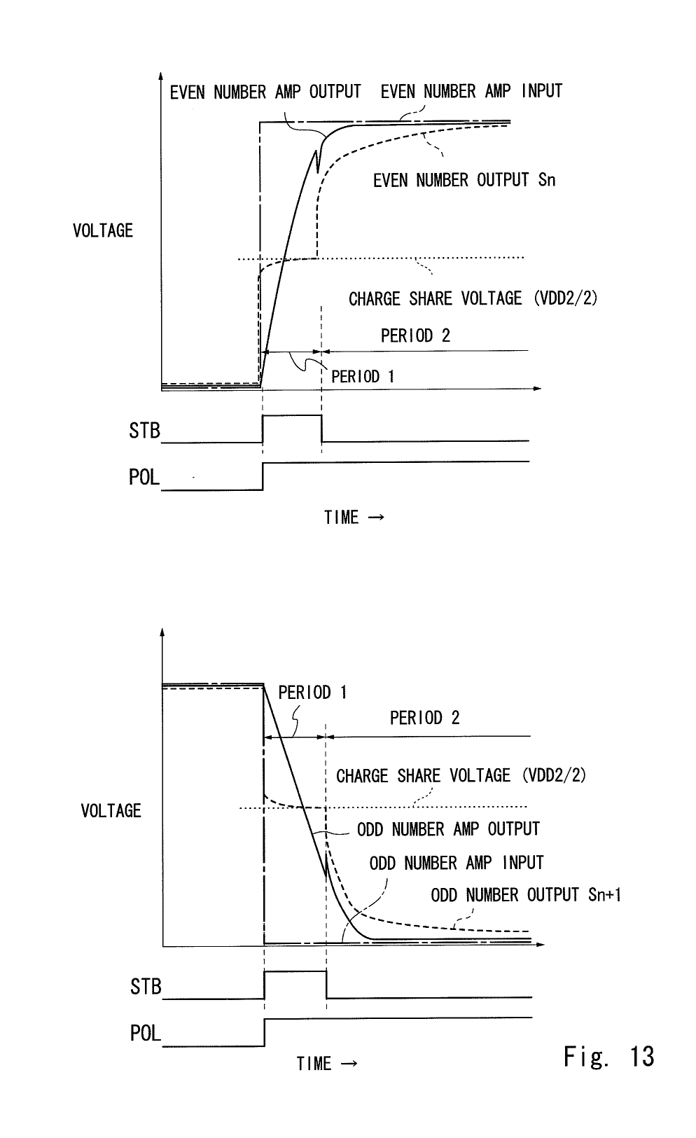

A drive circuit according to a second embodiment of the present invention is described hereinafter with reference to FIG. 5. FIG. 5 shows a configuration of a drive circuit. In this embodiment, the drive circuit has a configuration in which a data selector circuit SEL38 and a data selector circuit SEL39 are added to the circuit configuration shown in FIG. 12. Thus, the drive circuit of this embodiment includes an amplifier input selection switch SW35 in place of the output selection switch SW45 in the drive circuit of the first embodiment. Specifically, while the output selection switch SW45 is placed on the output side of the amplifier in the first embodiment, the amplifier input selection switch SW35 is placed on the input side of the amplifier in this embodiment. In such a configuration also, the same advantage as that of the first embodiment can be obtained. Note that the other configuration is the same as that of the drive circuit in FIG. 13 or the drive circuit of the first embodiment, and therefore detailed explanation thereof is omitted below.

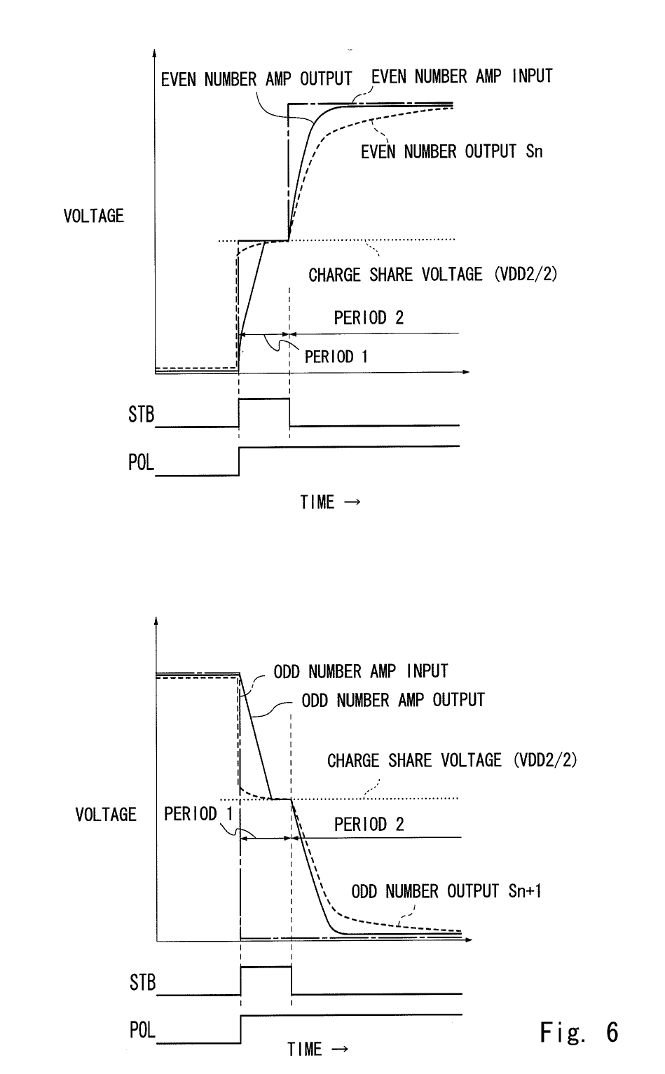

FIG. 6 shows an operating waveform of the drive circuit 5 according to the embodiment. In this embodiment, an even number Amp 33 is used for the even number output Sn, and an odd number Amp 34 is used for the odd number output Sn+1 regardless of positive or negative. It is thereby possible to reduce a deviation of a drive voltage and improve the picture quality. This thus enables driving with high picture quality.

### Third Embodiment

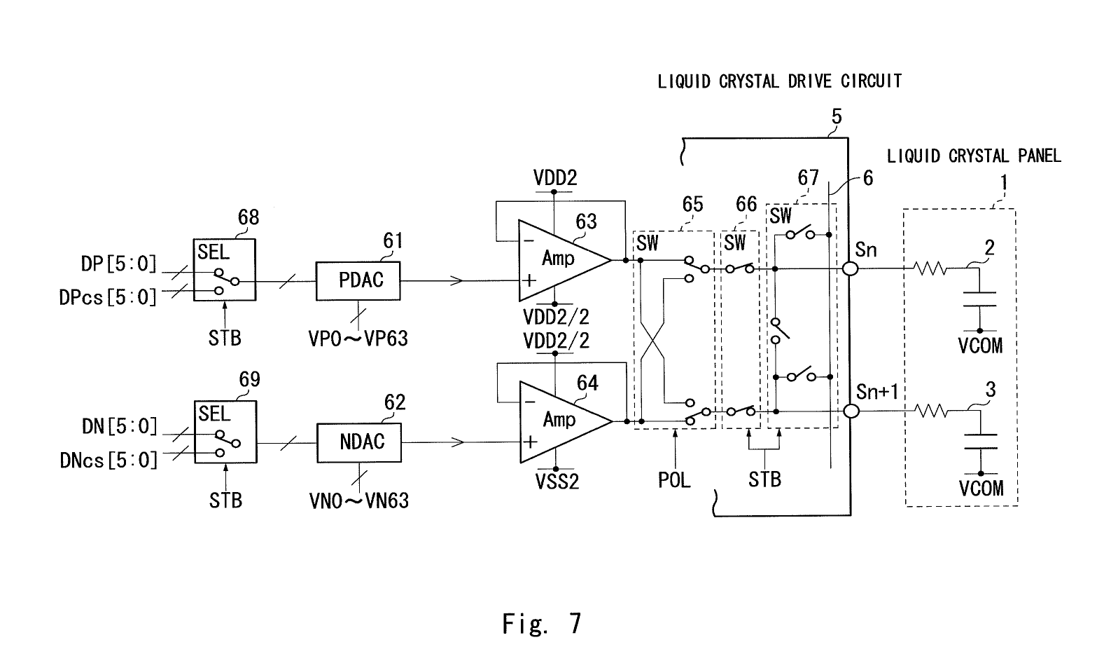

A drive circuit according to a third embodiment of the present invention is described hereinafter with reference to FIG. 7. FIG. 7 shows a configuration of a drive circuit. In this embodiment, a power supply voltage is half that of the drive circuit of the first embodiment. Specifically, the power supply of a positive Amp 63 is composed of VDD2 and ½ of VDD2, and the power supply of a negative Amp 64 is composed of ½ of VDD2 and VSS2. Thus, the bottom power supply of the positive Amp 63 and the top power supply of the negative Amp 64 are the same, i.e. ½ of VDD2. In such a configuration also, the same advantage as that of the first embodiment can be obtained. Note that, in this embodiment, the other configuration is the same as that of the drive circuit in FIG. 10 or the drive circuit of the first embodiment, and therefore detailed explanation thereof is omitted below.

Because the power supply voltage of each amplifier is reduced to the half in this embodiment, power consumption of the drive circuit 5 can be reduced. For example, the bottom power supply of the positive amplifier is set to VBOT (=½ of VDD2), and the top power supply of the negative amplifier is set to VTOP (=½ of VDD2). In the case of the normally white mode liquid crystal panel 1, the gamma VP63 and VN63 voltages are generally set to near VBOT+0.2V and VTOP−0.2V, respectively. If a voltage of ½ VDD2 is merely input to the amplifiers in the charge share period, the outputs of the both amplifiers are clamped to VTOP or VBOT, which is not preferable in terms of reliability. To avoid this, the drive circuit of this embodiment includes data selector circuits SEL68 and 69 for fixing data during the charge share period, so that input data during the charge share period is fixed to MSB. It is thereby possible to prevent the degradation of display quality and improve the reliability.

### Fourth Embodiment

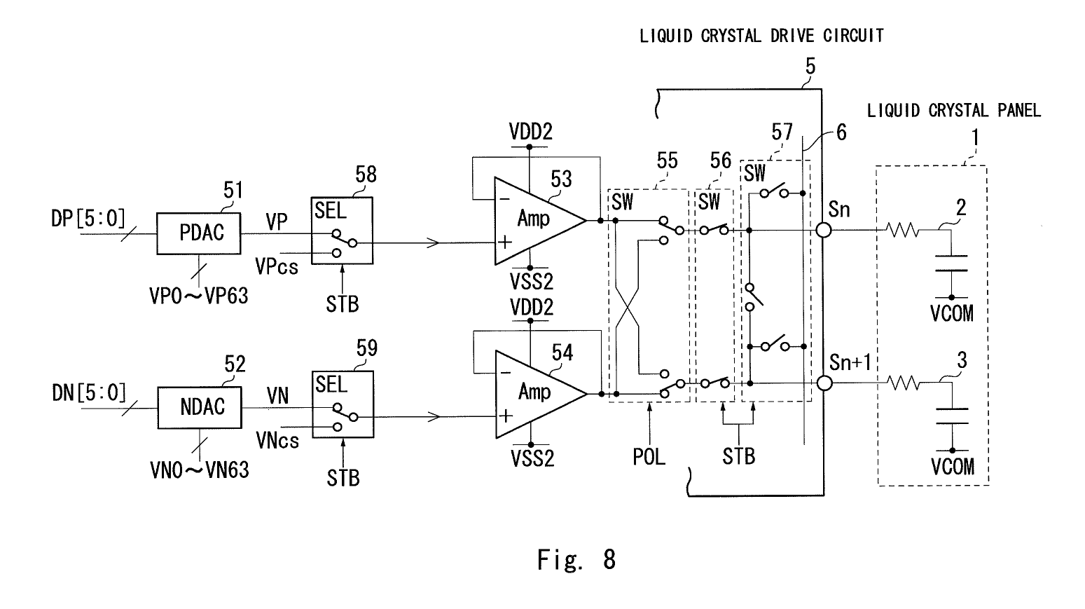

A drive circuit according to a fourth embodiment of the present invention is described hereinafter with reference to FIG. 8. FIG. 8 shows a configuration of a drive circuit 5. In this embodiment, the drive circuit 5 has a configuration in which amplifier input selector circuits SEL58 and 59 are added to the circuit configuration shown in FIG. 10. Thus, the drive circuit of this embodiment includes the amplifier input selector circuits SEL58 and 59 in place of the data selector circuits SEL48 and 49 in the drive circuit 5 of the first embodiment. Specifically, in this embodiment, the data selector circuit SEL48 and the data selector circuit SEL49 are eliminated. Further, the amplifier input selector circuit SEL58 is placed between the PDAC 51 and the positive Amp 53, and the amplifier input selector circuit SEL59 is placed between the NDAC 52 and the negative Amp 54. Note that, in the following description, the same explanation as those in the above embodiments is omitted as appropriated.

A gray scale voltage VP that is selected by a PDAC 51 and a fixed voltage VPcs for charge sharing are input to the amplifier input selector circuit SEL58. The amplifier input selector circuit SEL58 includes switches, and it switches its output according to the data output timing signal STB. For example, when the data output timing signal STB is H, the amplifier input selector circuit SEL58 selects and outputs the fixed voltage VPcs, and when the data output timing signal STB is L, the amplifier input selector circuit SEL58 selects and outputs the gray scale voltage VP. The gray scale voltage VP or the fixed voltage VPcs that is output from the amplifier input selector circuit SEL58 is input to the positive Amp 53. Note that the fixed voltage VPcs is the charge share voltage or a voltage close to the charge share voltage. Thus, the fixed voltage VPcs corresponds to the gray scale voltage that is selected by the PDAC 41 according to the charge share gray scale data DPcs in the first embodiment.

On the other hand, a gray scale voltage VN that is selected by a NDAC 52 and a fixed voltage VNcs for charge sharing are input to the amplifier input selector circuit SEL59. The amplifier input selector circuit SEL59 includes switches, and it switches its output according to the data output timing signal STB. For example, when the data output timing signal STB is H, the amplifier input selector circuit SEL59 selects and outputs the fixed voltage VNcs, and when the data output timing signal STB is L, the amplifier input selector circuit SEL58 selects and outputs the gray scale voltage VN. The gray scale voltage VN or the fixed voltage VNcs that is output from the amplifier input selector circuit SEL59 is input to the negative Amp 54. Note that the fixed voltage VNcs is the charge share voltage or a voltage close to the charge share voltage. Thus, the fixed voltage VNcs corresponds to the gray scale voltage that is selected by the NDAC 42 according to the charge share gray scale data DNcs in the first embodiment.

The operation of the drive circuit 5 according to the embodiment is described hereinbelow. The state where the polarity inversion signal POL is H and the data output timing signal STB is H is as follows. The PDAC 51 outputs a gray scale voltage VP0 to VP63 corresponding to gray scale data DP[5:0] that is input from a timing controller or the like. The PDAC 51 outputs the selected gray scale voltage VP to the amplifier input selector SEL58. Likewise, the NDAC 52 outputs a gray scale voltage VN0 to VN63 corresponding to gray scale data DN[5:0] that is input from a timing controller or the like. The NDAC 52 outputs the selected gray scale voltage VN to the amplifier input selector circuit SEL59.

When the data output timing signal STB is H, the amplifier input selector circuit SEL58 and 59 respectively select the fixed voltages VPcs and VNcs. The selected fixed voltages VPcs and VNcs are respectively output to the positive Amp 53 and the negative Amp 54.

When the polarity inversion signal POL is H, the output selection switch SW55 connects the output of the positive Amp 53 to the even number output Sn and connects the output of the negative Amp 54 to the odd number output Sn+1. Further, when the data output timing signal STB is H, the switches of the output switch SW56 are OFF, and the switches of the charge share switch SW57 are ON. The charge share period thereby occurs, and charges accumulated in loads are recovered. At this time, the fixed voltages VPcs and VNcs are respectively input to the positive Amp 53 and the negative Amp 54. Therefore, the outputs of the positive Amp 53 and the negative Amp 54 change to the charge share voltage or a voltage close to the charge share voltage.

Next, the time after transition to the state where the polarity inversion signal POL is H and the data output timing signal STB is L is as follows. The switches of the output switch SW56 become ON, and the switches of the charge share switch SW57 become OFF. Thus, the output of the positive Amp 53 is connected to the even number output Sn, and the output of the negative Amp 54 is connected to the odd number output Sn+1 through the output switch SW56 and the output selection switch SW55.

Further, the amplifier input selector circuit SEL58 selects the gray scale voltage VP corresponding to the gray scale data DP[5:0]. The gray scale voltage VP corresponding to the gray scale data DP[5:0] is thereby input to the positive Amp 53. Accordingly, the even number output Sn rises up to the gray scale voltage VP according to a change in the output voltage of the positive Amp 53. Likewise, the amplifier input selector circuit SEL59 selects the gray scale voltage VN corresponding to the gray scale data DN[5:0]. The gray scale voltage VN corresponding to the gray scale data DP[5:0] is thereby input to the negative Amp 54. Accordingly, the odd number output Sn+1 falls down to the gray scale voltage VN according to a change in the output voltage of the negative Amp 54. A desired image is thereby displayed.

This embodiment employs the configuration that supplies the fixed voltages VPcs and VNcs to the subsequent stage of the DACs, not supplying the fixed charge share gray scale data DPcs and DNcs to the DACs. In this embodiment also, the same advantage as that of the first embodiment can be obtained. The fixed voltages VPcs and VNcs may be the charge share voltage (½ of VDD2) or a gray scale voltage (MSB or LSB) which is the closest to the charge share voltage. Alternatively, the fixed voltages VPcs and VNcs may be a gray scale voltage corresponding to gray scale data in which the high order bit is the same value as that of the gray scale data corresponding to the gray scale voltage which is closest to the charge share voltage.

It should be noted that, although the embodiment employs the configuration in which the amplifier input selector circuits SEL58 and 59 are added to the drive circuit shown in FIG. 10, the configuration in which the amplifier input selector circuits SEL58 and 59 are added to the drive circuit shown in FIG. 12 may be employed. In this case, the amplifier input selector circuits SEL58 and 59 are placed in the previous stage of the amplifier input selection switch SW25.

Alternatively, the amplifier input selector circuits SEL58 and 59 may be incorporated into the amplifier input selection switch SW25. Particularly, when using the same charge share voltage (½ of VDD2) for the fixed voltages VPcs and VNcs, the amplifier input selection switch SW25 may short-circuit the input terminal of the even number Amp 23 and the input terminal of the odd number Amp 24 and connect them to the power supply of ½ of VDD2.

### Fifth Embodiment

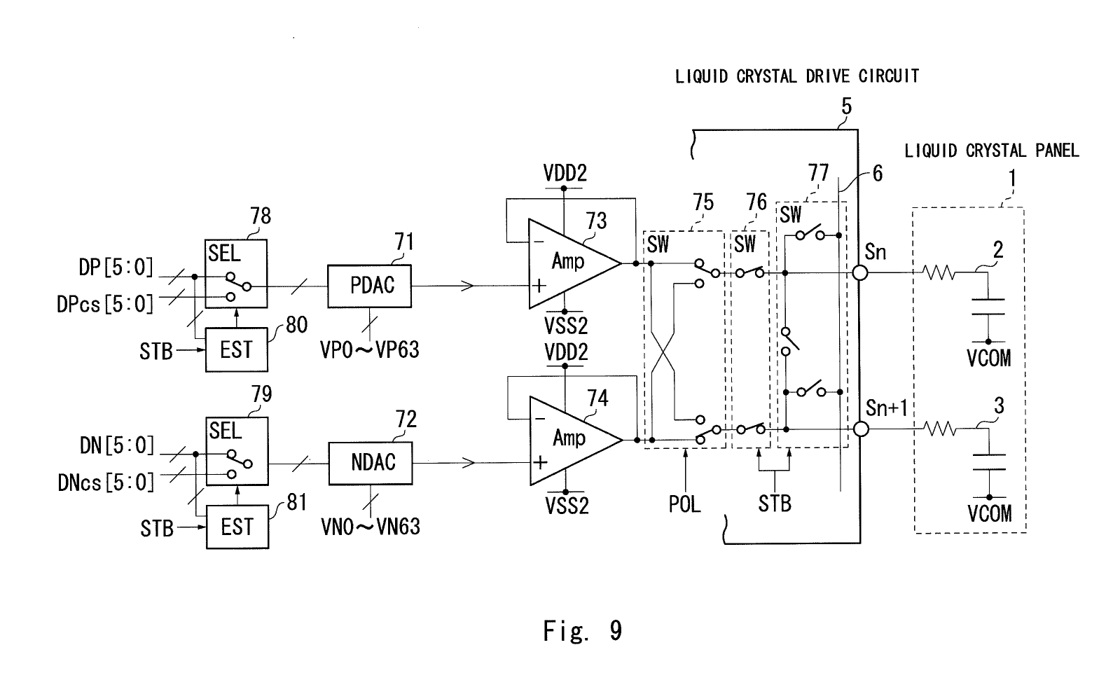

A drive circuit according to a fifth embodiment of the present invention is described hereinafter with reference to FIG. 9. FIG. 9 shows a configuration of a drive circuit 5. In this embodiment, data estimation circuits 80 and 81 are added to the drive circuit 5 according to the first embodiment. The data estimation circuit 80 controls a data selector circuit SEL78 according to the data output timing signal STB and the gray scale data DP[5:0]. The data estimation circuit 81 controls a data selector circuit SEL79 according to the data output timing signal STB and the gray scale data DN[5:0].

Specifically, the data estimation circuit 80 compares the gray scale data DP[5:0] for display with a predetermined gray scale threshold and outputs a comparison result to the data selector circuit SEL78. Then, the data selector circuit SEL78 selects one of the gray scale data DP and the charge share gray scale data DPcs according to the comparison result. Therefore, there are cases where the gray scale data DP is selected even when the data output timing signal STB is H. Specifically, the data selector circuit SEL78 selects the gray scale data DP[5:0] when the gray scale voltage corresponding to the gray scale data DP[5:0] is close to the charge share voltage, and selects the charge share gray scale data DPcs[5:0] when the gray scale voltage corresponding to the gray scale data DP[5:0] is significantly different from the charge share voltage and when the data output timing signal STB is H. Thus, only when the data output timing signal STB is H under the condition that the output voltage of the PDAC 71 is greater than a gray scale voltage with the threshold gray scale data, the data estimation circuit 80 controls the data selector circuit SEL78 to select DPcs[5:0]. The threshold may be a value that is determined by way of experiment according to the display device.

Likewise, the data estimation circuit 81 compares the gray scale data DN[5:0] with a threshold and controls the data selector circuit SEL79 according to a comparison result. Thus, the data selector circuit SEL79 selects the gray scale data DN[5:0] when the gray scale voltage corresponding to the gray scale data DN[5:0] is close to the charge share voltage, and selects the charge share gray scale data DNcs[5:0] when the gray scale voltage corresponding to the gray scale data DN[5:0] is significantly different from the charge share voltage and when the data output timing signal STB is H.

As described above, when each of the gray scale data DP[5:0] and DN[5:0] for display is close to the charge share gray scale data, the gray scale data DP[5:0] and the gray scale data DN[5:0] are selected even during the charge share period. It is thereby possible to prevent the time to stabilize the output from being excessively long. Note that the data estimation circuits 80 and 81 of the drive circuit 5 according to this embodiment may be added to the drive circuit 5 according to the second to fourth embodiments.

### Other Embodiments

In the drive circuit described above, the PDACs 31, 41, 51, 61 and 71 are the positive DAC circuit, and the NDACs 32, 42, 52, 62 and 72 are the negative DAC circuit. The positive DAC circuit selects a positive gray scale voltage according to gray scale data, and the negative DAC circuit selects a negative gray scale voltage according to gray scale data.

The positive Amp 43, the positive Amp 53, the positive Amp 63 and the positive Amp 73 are the positive amplifier circuit, and the negative Amp 44, the negative Amp 54, the negative Amp 64 and the negative Amp 74 are the negative amplifier circuit. The even number Amp 33 is the amplifier circuit for even number output, and the odd number Amp 34 is the amplifier circuit for odd number output.

Further, the amplifier input selection switch SW35, the output selection switch SW45, the output selection switch SW55, the output selection switch SW65 and the output selection switch SW75 are the negative-positive inverter circuit. The negative-positive inverter circuit switches between a first operation for supplying a positive gray scale voltage to a first data line group and supplying a negative gray scale voltage to a second data line group, and a second operation for supplying a positive gray scale voltage to the second data line group and supplying a positive negative gray scale voltage to the first data line group.

The output switch SW36, the output switch SW46, the output switch SW56, the output switch SW66 and the output switch SW76 are the amplifier output cutoff circuit. The amplifier output cutoff circuit performs switching to disconnect the positive and negative amplifier outputs from the data lines.

The charge share switch SW37, the charge share switch SW47, the charge share switch SW57, the charge share switch SW67 and the charge share switch SW77 are the charge share circuit. The charge share circuit short-circuits a data line in the first data line group and a data line in the second data line group during the switching period.

The data selector circuits SEL38 and 39, the data selector circuits SEL48 and 49, the data selector circuits SEL58 and 59, the data selector circuits SEL68 and 69 and the data selector circuits SEL78 and 79 are the amplifier input switch circuit that switches the input of the amplifier during the charge share period.

The above-described first to fifth embodiments can be combined as desirable by one of ordinary skill in the art. Further, the drive circuit 5 according to the first to fifth embodiments may be used for a display panel different from the liquid crystal panel 1.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A drive circuit that supplies a gray scale voltage to a plurality of data lines included in a display panel, the drive circuit comprising:
a positive DAC circuit that selects a positive gray scale voltage according to gray scale data;
a negative DAC circuit that selects a negative gray scale voltage according to gray scale data;
an amplifier circuit that is connected to each of the positive DAC circuit and the negative DAC circuit;
a negative-positive inverter circuit that switches between a first operation for supplying the positive gray scale voltage to a first data line group and supplying the negative gray scale voltage to a second data line group, and a second operation for supplying the positive gray scale voltage to the second data line group and supplying the negative gray scale voltage to the first data line group;
an amplifier output cutoff circuit that makes switching to disconnect an amplifier output of the amplifier circuit from the data lines during a switching period of the first operation and the second operation;
a charge share circuit that short-circuits a data line in the first data line group and a data line in the second data line group during the switching period; and
an amplifier input switch circuit that sets an input of the amplifier circuit to a fixed voltage not dependent on a gray scale voltage corresponding to gray scale data for display during the switching period.

2. The drive circuit according to claim 1, wherein the fixed voltage is a charge share voltage or a voltage closer to the charge share voltage than a voltage in a gray scale voltage range.

3. The drive circuit according to claim 1, wherein
charge share gray scale data corresponding to the fixed voltage and the gray scale data are input to the amplifier input switch circuit, and
the amplifier input switch circuit selects and outputs the charge share gray scale data to the positive DAC circuit and the negative DAC circuit during the switching period, so that the fixed voltage is input to the amplifier circuit.

4. The drive circuit according to claim 1, wherein the fixed voltage is a gray scale voltage corresponding to MSB or LSB.

5. The drive circuit according to claim 1, wherein
DAC outputs of the positive DAC circuit and the negative DAC circuit and the fixed voltage are input to the amplifier input switch circuit, and
the amplifier input switch circuit selects and outputs the fixed voltage to the amplifier circuit during the switching period.

6. The drive circuit according to claim 1, wherein
when the gray scale voltage corresponding to the gray scale data for display is closer to a charge share voltage than a specified threshold voltage included in a gray scale voltage range, the gray scale voltage corresponding to the gray scale data for display is input to the amplifier circuit, and
when the gray scale voltage corresponding to the gray scale data for display is less closer to the charge share voltage than the specified threshold voltage included in the gray scale voltage range, the fixed voltage is input to the amplifier circuit during the switching period.

7. A display device comprising:
the drive circuit according to claim 1; and
a display panel that includes a data line supplied with the gray scale voltage from the drive circuit.

8. A drive method that supplies a gray scale voltage to a plurality of data lines included in a display panel, the method comprising:
performing a first operation for supplying a positive gray scale voltage to a first data line group and supplying a negative gray scale voltage to a second data line group, and a second operation for supplying the positive gray scale voltage to the second data line group and supplying the negative gray scale voltage to the first data line group, in an alternate manner;
making switching to disconnect an amplifier output of an amplifier circuit that supplies the positive gray scale voltage and the negative gray scale voltage to the data lines from the data lines during a switching period of the first operation and the second operation;
short-circuiting a data line in the first data line group and a data line in the second data line group during the switching period; and
setting an input of the amplifier circuit that supplies the positive gray scale voltage and the negative gray scale voltage to the data lines to a fixed voltage not dependent on a gray scale voltage corresponding to gray scale data for display during the switching period.

9. The drive method according to claim 8, wherein the fixed voltage is a charge share voltage or a voltage closer to the charge share voltage than a voltage in a gray scale voltage range.

10. The drive method according to claim 8, wherein
in the first operation and the second operation, a positive DAC circuit and a negative DAC circuit respectively select the positive gray scale voltage and the negative gray scale voltage based on the gray scale data for display, and
charge share gray scale data is selected and output to the positive DAC circuit and the negative DAC circuit during the switching period, so that the fixed voltage is input to the amplifier circuit.

11. The drive method according to claim 8, wherein the fixed voltage is a gray scale voltage corresponding to MSB or LSB.

12. The drive method according to claim 8, wherein
in the first operation and the second operation, a positive DAC circuit and a negative DAC circuit respectively select the positive gray scale voltage and the negative gray scale voltage based on the gray scale data for display, and
DAC outputs of the positive DAC circuit and the negative DAC circuit and the fixed voltage are input to an amplifier input switch circuit, and the amplifier input switch circuit selects and outputs the fixed voltage to the amplifier circuit during the switching period.

13. The drive method according to claim 8, wherein
when the gray scale voltage corresponding to the gray scale data for display is closer to a charge share voltage than a specified threshold voltage included in a gray scale voltage range, the gray scale voltage corresponding to the gray scale data for display is input to the amplifier circuit, and
when the gray scale voltage corresponding to the gray scale data for display is less closer to the charge share voltage than the specified threshold voltage included in the gray scale voltage range, the fixed voltage is input to the amplifier circuit during the switching period.
